(19) United States
(12) Patent Application Publication
(10) Pub. No.: US 2004/0179896 A1
(43) Pub. Date: Sep. 16, 2004

(54) Concrete receptacle assembly and method for using the same to creat synthetic riprap blocks

(76) Inventors: John Edgar Curry, Opelika, AL (US); Wiliam Leon Pinkston, Montgomery, AL (US)

Correspondence Address: SMITH, GAMBRELL & RUSSELL, LLP, SUITE 3100, PROMENADE II, 1230 PEACHTREE STREET, N.E., ATLANTA, GA, 30309-3592, US

(21) Appl. No.: 10/801,026

(22) Filed: Mar. 15, 2004

Related U.S. Application Data
(60) Provisional application No. 60/454,938, filed on Mar. 14, 2003.

(51) Int. Cl. E02B 3/12; B41B 11/54

(52) U.S. Cl. 405/16; 249/171

(57) ABSTRACT

A concrete receptacle assembly includes a frame that supports a series of cells that are used to receive waste concrete and mold the waste concrete into synthetic riprap blocks. The cells are defined by a series of angled partitions that are mounted within the frame, with the angled partitions defining the shape of the synthetic riprap blocks produced. In operation, the waste concrete is distributed into the cells, where it is allowed to cure for a predetermined period of time. Once cured, the concrete receptacle assembly is upended such that the synthetic riprap blocks will be dislodged from the cell. Once the synthetic riprap blocks have been extracted, the concrete receptacle assembly is prepped for the next cycle of production.

### CROSS REFERENCE TO RELATED APPLICATION

The present application claims benefit of Provisional Patent Application No. 60/454,938, filed on Mar. 14, 2003.

### FIELD OF THE INVENTION

The present invention generally relates to the field of concrete reclamation, and more particularly, the present invention relates to a concrete receptacle assembly that facilitates the disposal of concrete waste and recycling said concrete waste for use as riprap.

### BACKGROUND OF THE INVENTION

The concrete industry wastes significant amounts of concrete each year. Concrete batch plants tend to waste on average one yard of concrete per day for each truck used to transport the concrete. While there are multiple reasons concerning why waste concrete is produced, one substantial reason is that contractors and persons in the construction industry order too much concrete for a particular job. As a result, the disposal of the unused, waste concrete is a major concern for the construction industry as well as for environmentalists.

Historically, several methods have been used for controlling the excess concrete produced at any particular work site. The most commonly used means for controlling waste concrete is a traditional washing out of the concrete mixer into a slurry. The benefit of such a system is that slurries commonly preexist at many work sites. Furthermore, the use of a slurry is easy for laborers due to the low maintenance requirements and the simple technological requirements. However, this system produces a cementitious slurry at the work site that is also expensive for disposal, not considering the extraordinary length of time that it takes to dispose of the slurry. In addition, this system requires an extensive yard space for the location of the slurry. A related means for disposing of waste concrete is a chemical wash out of the waste concrete from a mixer. However, such a method requires a significant initial capital investment as well as high ongoing costs.

Another method for the disposal of waste concrete is referred to as “stoning out”, wherein the hardened concrete is pulverized and distributed at a desired location. While this requires little capital costs, it does require ground storage and the pulverized concrete may not be suitable for use after multiple mixes.

One final method for reusing concrete is to employ a reclaimer, which will maintain the concrete in a somewhat fluid form for later use. While this allows for use of all materials, it has high capital costs and high maintenance costs. Moreover, it requires constant supervision and a consistently high production plant to work efficiently.

### SUMMARY OF THE INVENTION

The present invention provides a concrete receptacle assembly that is used to receive waste concrete and mold the waste concrete into synthetic riprap. Specifically, the concrete receptacle assembly includes a frame surrounding a series of cells used to receive waste concrete from construction worksites and related areas. The concrete receptacle assembly is then arranged in such a way so that it may be turned over without interference from nearby obstructions. Once the cells of the concrete receptacle assembly are filled, the excess concrete is then leveled off of the top using a screed and the top layer is patted to provide a smooth surface.

The concrete is then allowed to cure in the cells of the concrete receptacle assembly for a predetermined amount of time corresponding to the size of the cells and the depth of the concrete. Once cured, the concrete receptacle assembly is upended such that the concrete riprap blocks will be dispelled when the concrete receptacle assembly makes contact with the ground. Once the synthetic riprap blocks have been extracted, the concrete receptacle assembly is prepped for the next cycle of production.

### BRIEF DESCRIPTION OF THE DRAWINGS

A concrete receptacle assembly embodying the features of the present invention is depicted in the accompanying drawings which form a portion of this disclosure, wherein:

FIG. 1 is a perspective view of the concrete receptacle assembly of the present invention;

FIG. 2 is a top plan view of the concrete receptacle assembly of the present invention;

FIG. 3 is a bottom view of the concrete receptacle assembly of the present invention;

FIG. 4 is a front elevational view of the concrete receptacle assembly of the present invention taken along lines 4--4 of FIG. 1;

FIG. 5 is a rear elevational view of the concrete receptacle assembly of the present invention taken along lines 5--5 of FIG. 1;

FIG. 6 is a first side elevational view of the concrete receptacle assembly of the present invention taken along lines 6--6 of FIG. 2;

FIG. 7 is a second side elevational view of the concrete receptacle assembly of the present invention taken along lines 7--7 of FIG. 2;

FIG. 8 is a perspective view of an upended embodiment of the concrete receptacle assembly, with a vehicle for upending the concrete receptacle assembly proximate the concrete receptacle assembly;

FIG. 9 is a side elevational view of one cell from the concrete receptacle assembly, said view illustrating the various angles of the tapered edges of said cell;

FIG. 10a is a sectional view of the concrete receptacle assembly taken along the lines 10a--10a of FIG. 2;

FIG. 10b is a sectional view of the concrete receptacle assembly taken along the lines of 10b--10b of FIG. 2; and

FIG. 11 is a side elevational view of one embodiment of the concrete receptacle assembly having a railing.

### DESCRIPTION OF THE PREFERRED EMBODIMENTS

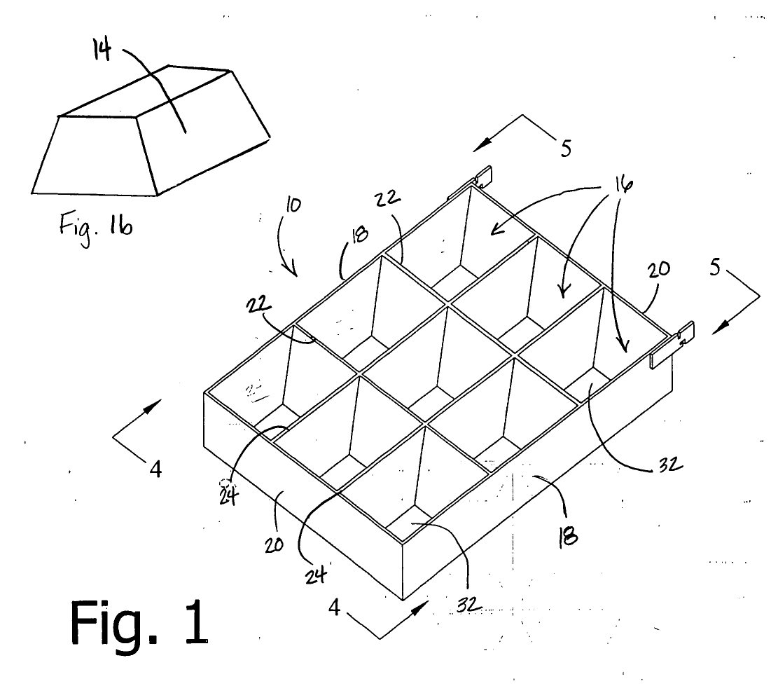

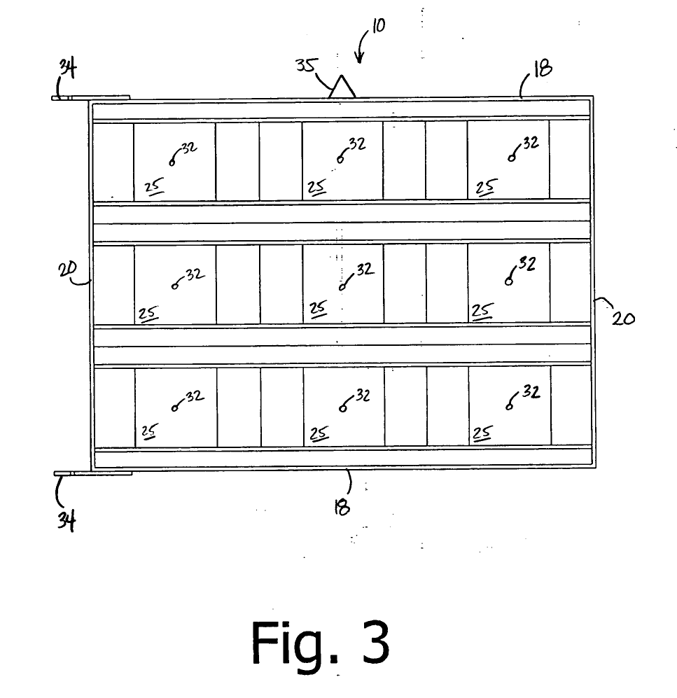

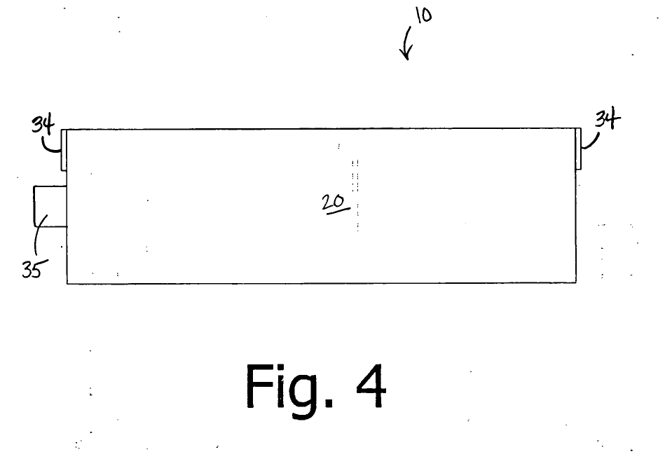

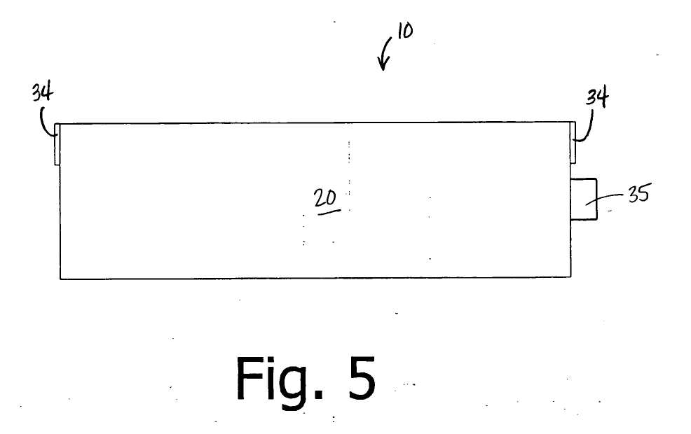

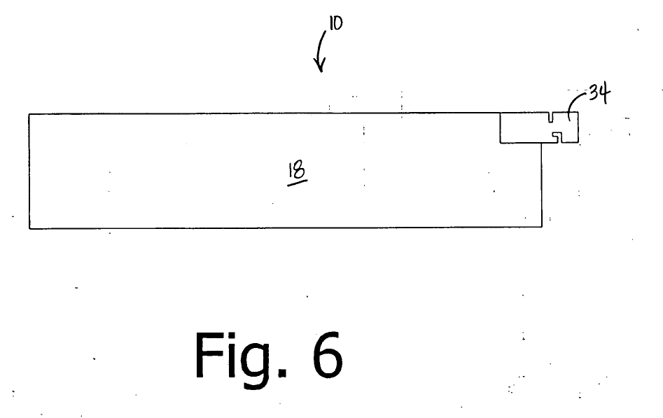

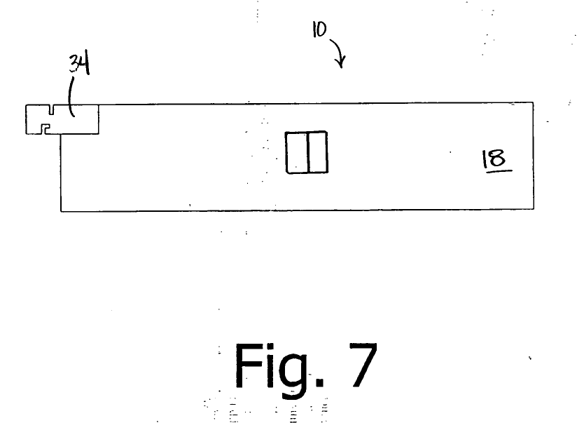

Referring to the figures for a better understanding of present invention, it will be appreciated that the present invention comprises a concrete receptacle assembly 10 that is transportable to a location having waste concrete (not illustrated), such as a construction work site, a cement plant, or other concrete facility, to receive excess waste concrete which is otherwise not useful and must be disposed of by the user. In particular, the concrete receptacle assembly 10, as illustrated in FIGS. 1-7, forms the waste concrete into synthetic, formed riprap blocks 14 (as illustrated in FIG. 1b) that may be used for a variety of purposes. For example, the synthetic riprap blocks 14 may be used for pier and abutment protection at new and existing bridges, for inlet and outlet protection at new and existing culverts, for river and creek stream training, for spillways, for general erosion control, and numerous other related applications.

The concrete receptacle assembly 10 of the present invention includes an outer frame 16 or wall made of a steel plate or multiple steel plates that are welded together. While steel plates are used in one embodiment of the invention, it should be noted that other embodiments of the invention may include an outer frame 16 made of sheet metal, cast metal, plastics, or a related material having the strength and durability required to hold the waste concrete and eject the riprap blocks 14 efficiently.

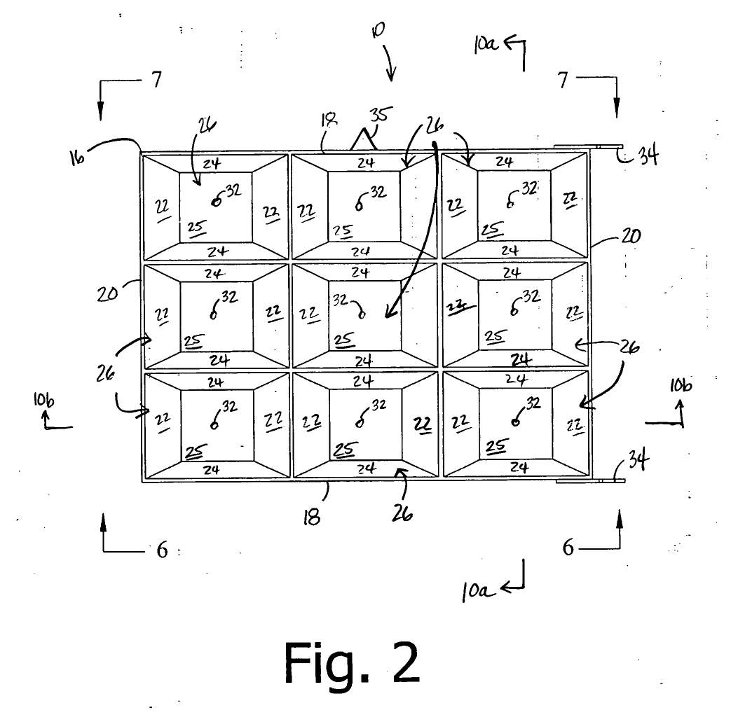

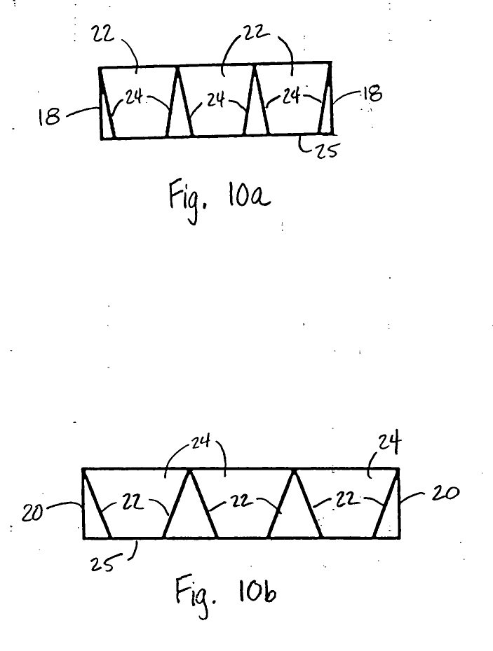

In the embodiment illustrated in FIG. 1, the outer frame 16 has a rectangular shape with two horizontal walls 18 that are connected to two vertical walls 20. A variety of inner partitions 22, 24 (such as plates or walls) are further connected together and to the inner surface of the surrounding outer frame 16. Looking to FIG. 1, one or more vertical partitions 22 are connected between the horizontal walls 18 and one or more horizontal partitions 24 are connected between the verticals walls 20 to form synthetic riprap cells 26. In the embodiment shown in FIGS. 2, 10a and 10b, there are three pairs of vertical partitions 22, with each vertical partition 22 of each pair sloping towards each other. Likewise, there are three pairs of horizontal partitions 24, with each horizontal partition 22 of the pair sloping toward each other. Finally, a set of base plates 25 are connected between the vertical partitions 22 of each pair and the horizontal partitions 24 of each pair to provide a bottom surface for the cell 26. Thus, each cell 26 will have an open side to receive waste concrete and a closed base 25 to contain the waste concrete. As a result, the frame 16 of the concrete receptacle assembly 10 supports the various cells 26 that will receive and hold the waste concrete.

It should be noted that while the frame 16 of the embodiment illustrated in FIGS. 1-7 is rectangular, any number of geometrical shapes could be incorporated into the present design to achieve the shape of the cells 26 (and thus the synthetic riprap blocks 14) as desired by the user. Additionally, the cells 26 generally have a trapezoidal or rectangular cross-section, with tapered sides that ease the extraction of the synthetic riprap blocks 14 from the concrete receptacle assembly 10, as discussed herein. Synthetic riprap blocks 14 are designed to have specific weight and size dimensions according to specifications as desired by the users of conventional riprap and as set by various governing authorities, such as the Department of Transportation and the Federal Highway Administration. Thus, the concrete receptacle assemblies 10 will vary in size, and will be used daily for stockpiling the synthetic riprap 14 in size and shape as desired by the user. Furthermore, it should be noted that the shape of the cells 26 may be adjusted to create synthetic riprap blocks 14 of different shapes, such as cylindrical blocks or triangular blocks.

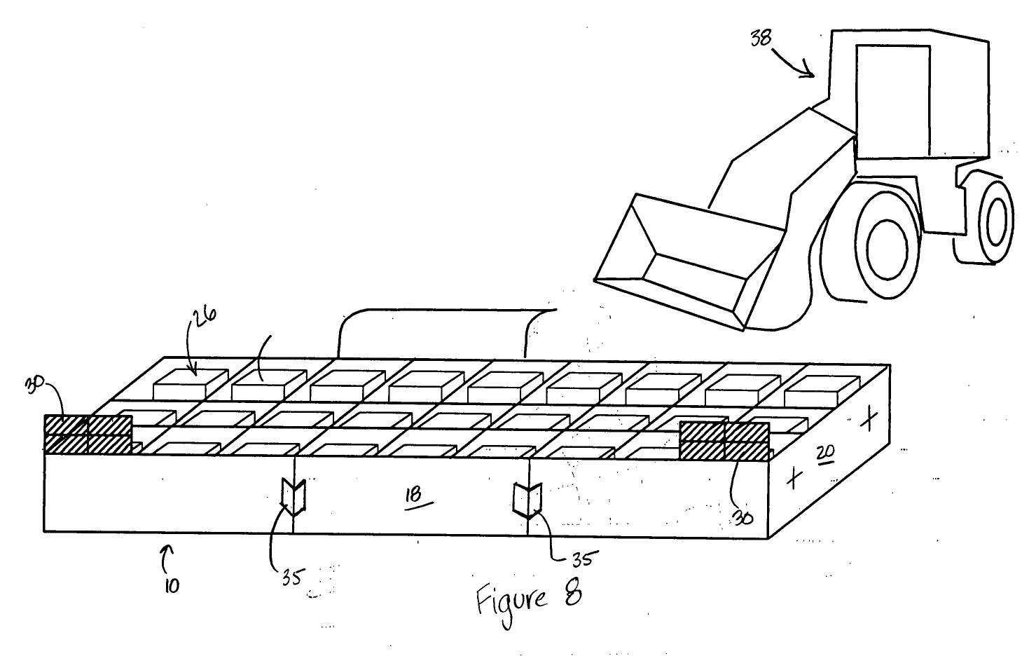

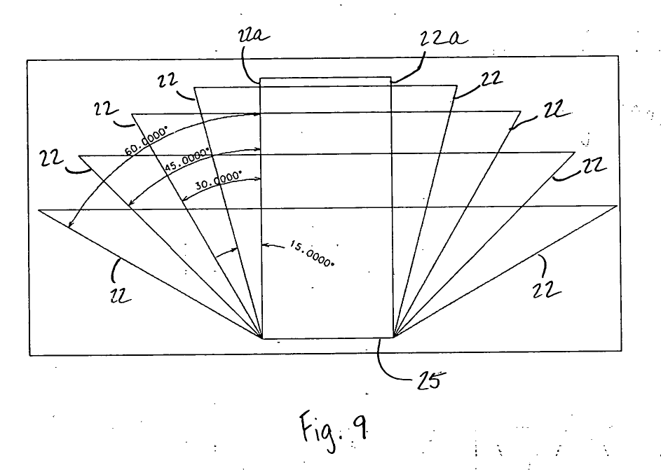

Moreover, the concrete receptacle assemblies 10 may have any number of rows and columns of cells 26. For example, the embodiment illustrated in FIG. 1 includes three cells 26 in each row by three cells 26 in each column. However, any number of other designs, with a variety of cell components, may be provided. For example, the concrete receptacle assembly 10 may include three cells 26 in a row by twelve cells 26 in a column, six cells 26 in a row by six cells 26 in a column, or five cells 26 in a row by two cells 26 in a column. The number of cells 26 is determined according to the desired size of the synthetic riprap blocks 14 and the available room for operation of the concrete receptacle assembly 10 at the construction work site or batch plant. That is, the larger the desired riprap blocks 14, the fewer cells 26 in each concrete receptacle assembly 10. Furthermore, it is foreseen that individual concrete receptacle assemblies 10 may be connected to each other to create the desired number of cells 26 to receive waste concrete. As shown in FIG. 8, three concrete receptacle assemblies 10 are welded together, with a clasp 35 (discussed further herein) being connected to adjacent sides of concrete receptacle assemblies 10 to reinforce the connection.

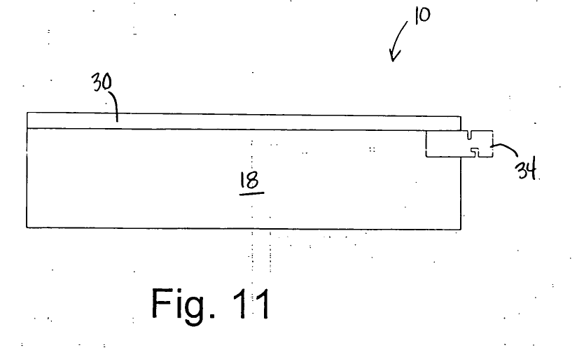

Looking to FIG. 11, the horizontal side walls 18 may be extended above the top surface of the concrete receptacle assembly 10 to form a railing 30. The railing 30 will prevent any undesired run over of waste concrete from the concrete receptacle assembly 10, and will keep the concrete in the desired cells 26.

As stated above, the present invention is used to create synthetic riprap 14 from the waste concrete and cement that is commonly found at concrete batch plants, cement plants, pipe plants, and other concrete facilities. The process of recycling waste concrete as synthetic riprap blocks 14 involves the step of initially placing the concrete receptacle assembly 10 (or multiple assemblies) on a substantially hard surface. If multiple concrete receptacle assemblies 10 are used, they are lined up side by side.

Once arranged, a lubricating substance (not illustrated) is then dispersed onto each cell 26 of the concrete receptacle assembly 10 to prepare the cell 26 to receive the waste concrete. The lubricating substance can be any type known in the art, such as form oil or hydraulic oil, although it is desired that the lubricant be environmentally safe. The waste concrete is then poured into one or more cells 26 of each concrete receptacle assembly 10. Each independent cell 26 is substantially filled before proceeding to fill adjacent cells 26, such that the amount of waste concrete and cement determines the number of cells 26 that are filled. The railing 30 directs the waste concrete to flow into the next cell 26 or adjacent concrete receptacle assembly 10 once the current cell 26 or current concrete receptacle assembly 10 has been filled, thereby helping to prevent the undesired spilling of waste concrete from the concrete receptacle assembly 10.

The concrete receptacle assemblies 10 are then stored or set for a period of time, with the waste concrete stored therewith in the cells 26. During this time, the waste concrete will cure into the synthetic riprap blocks 14 desired by the user. While the time required for curing will vary according to the size and shape of the cells 26, it has been found that a curing time of eight to twelve hours will be sufficient to allow the waste cement to harden into synthetic riprap blocks 14.

Once the synthetic riprap blocks 14 have cured, the concrete receptacle assembly 10 is ready to be flipped or inverted to dislodge the synthetic riprap blocks 14 from the concrete receptacle assembly 10. In one embodiment of the invention, a chain, or a hook connected to a chain (not illustrated) may be attached to a front-end loader 38, tractor, bulldozer or other piece of machinery, which can then be connected to a bracket 34, clasp 35, handle, or other attachment means connected to the concrete receptacle assembly 10. In one embodiment, the hook is attached to the bucket of the front-end loader 38 using a chain, and the user is able to engage the clasp 35 with the hook. Upward movement of the bucket will then lift the concrete receptacle assembly 10 by the clasp 35 to pick-up or roll concrete receptacle assembly 10 to an inverted position (see FIG. 8). In addition, the chain may be connected directly to the concrete receptacle assembly 10 to cause this movement, and the bucket of the front-end loader 38 may directly engage the concrete receptacle assembly 10 to upend the concrete receptacle assembly 10.

Once the concrete receptacle assemblies 10 are rolled, the synthetic riprap 14 will fall out from the concrete receptacle assembly 10, either when the top side of the concrete receptacle assembly 10 strikes the ground surface or prior to that force. The synthetic riprap blocks 14 are then pushed into a pile and the concrete receptacle assembly 10 is oiled once again and made ready for the next cycle of production. The lubricating substance dispersed in the cells 26 will aid in unloading of the synthetic riprap 14. The user will then be able to push the synthetic riprap 14 into a pile for transport to the desired location.

The present invention was tested at a concrete plant where three concrete receptacle assemblies 10 were utilized. The concrete receptacle assemblies 10 were filled with the waste concrete. Two concrete receptacle assemblies 10 were filled without screeding the top excess layer of waste concrete, and the other was filled just to the top of the cell 26. The next morning the concrete receptacle assemblies 10 were rolled and, while the synthetic riprap blocks 14 were green in appearance, the concrete synthetic riprap blocks 14 were nonetheless extracted. The concrete receptacle assembly 10 having the least amount of excess waste concrete in the cell 26 appeared to produce riprap blocks 14 with the desired structure that were dislodged with minor effort. The other two concrete receptacle assemblies 10 were filled to the point where concrete spilled across the edges, thereby combining each cell 26. After rolling the concrete receptacle assemblies 10, it was determined that the bond between cells 26 in the embodiment that was overfilled limited the smooth extraction of the riprap blocks 14 from the concrete receptacle assemblies 10. This led to the inclusion of a small hole 32 or aperture through the base plate 25 of each cell 26. This hole 32 makes extraction of the synthetic riprap blocks 14 easier, especially when the synthetic riprap blocks 14 are uncured and greenish in color.

It should be noted that testing found that certain synthetic riprap blocks 14 required more effort to dislodge the blocks 14 from the concrete receptacle assembly 10. In particular, it was found that the friction from the two flat sides on each side of the synthetic riprap block 14 prevented the riprap blocks 14 from being extracted easily, and required a substantial amount of bouncing and shaking of the concrete receptacle assemblies 10 to dislodge the riprap blocks 14. Consequently, this test led to a design wherein all of the sides of a cell 26 (that is, the horizontal partitions 24 and the vertical partitions 22) are tapered. By tapering the partitions 22, 24, the riprap blocks 14 were more easily dislocated.

The concrete receptacle assembly 10 addresses a number of problems in both the concrete industry and in the construction industry. For example, quarries that conventionally supply riprap are located in geographical areas corresponding to the presence of required rocks and minerals. In many instances, the quarries where riprap is extracted are distant from the locations where the riprap is needed. Consequently, significant costs are required for hauling the riprap erosion control to the distant sites. The present invention is able to produce synthetic riprap blocks 14 locally rather than at a distant location.

The concrete receptacle assembly 10 is simple to use, but has a complex system of elements that provides the ease of extraction of the riprap blocks 14. Specifically, each cell 26 of a concrete receptacle assembly 10 includes four tapered sides per unit; a small aperture 32 in the bottom of each cell 26 to prevent a suction of the riprap 14 to the cell 26; an extension is in place for allowing concrete to spill from one form to the next when lined up; and form oil is used to protect the concrete receptacle assembly 10 and to provide ease of extraction of the riprap block 14.

Referring to FIG. 10, a sectional side view of one cell 26 is illustrated, with the various potential angles of the vertical partitions 22 being shown. The vertical partitions 22 may be between 0 degrees to 60 degrees from the horizontal plane 22a, depending on the desired shape of the riprap block 14 for the desired use of the riprap block 14. For example, for cells 26 having vertical partitions 22 close to 0 degrees from the vertical plane 22a, the shape of the synthetic riprap 14 will be substantially rectangular. This will provide a steep angle of repose for each of the sides of the synthetic riprap 14, which allows for steeper piles when stockpiling the riprap 14 and less room to be taken up by storage of the riprap blocks 14 and for steeper placement of the riprap blocks 14 when used for erosion control. Like the vertical partitions 22, the horizontal partitions 24 may be tapered as desired by the user.

It should be noted that the completed synthetic riprap blocks 14 do not have to be hand-placed on the ground surface by a worker. Rather, the riprap blocks 14 have a sturdy production from the waste cement such that they can be dumped onto the ground surface and handled like conventional riprap used in the construction industry.

Through the use of waste concrete, the present invention provides a continuous, local supply of synthetic riprap 14 that can be produced as long as a concrete plant is in operation. Furthermore, the waste concrete is recycled and reused to create synthetic riprap to take the place or supplement the use of conventional riprap, the most commonly used product for erosion control. This will provide a lower cost to cities, counties, federal and departments of transportation or other organizations. Less waste concrete will provide a service to the community to prevent filling of public landfills and pollution to the environment. That is, currently the waste material will build up into large mounds of poorly graded sediment. However, the use of the present invention will reduce the wastewater that is associated with the concrete waste product, further aiding in the National Pollution Discharge Elimination System (NPDES) required by the Environmental Protection Agency (EPA)

Thus, although there have been described particular embodiments of the present invention of a new and useful CONCRETE RECEPTACLE ASSEMBLY AND METHOD FOR USING THE SAME, it is not intended that such references be construed as limitations upon the scope of this invention except as set forth in the following claims.

What is claimed is:

1. A concrete receptacle assembly using waste concrete to create formed riprap, said concrete receptacle assembly comprising:
a frame having an outer surface and an inner surface;
at least one first partition mounted within said frame;
at least one second partition mounted within said frame, said second partition intersecting with said first partition;
a base connecting said first partition with said second partition, wherein said base, said first partition and said second partition forming a cell within said frame to hold the waste concrete.

2. The concrete receptacle assembly as described in claim 1, wherein said at least one first partition is tapered from a vertical plane.

3. The concrete receptacle assembly as described in claim 2, wherein said at least one first partition is tapered from 0 to 60 degrees from a vertical plane.

4. The concrete receptacle assembly as described in claim 1, wherein said at least one second partition is tapered from a vertical plane.

5. The concrete receptacle assembly as described in claim 4, wherein said at least one second partition is tapered from 0 to 60 degrees from a vertical plane.

6. The concrete receptacle assembly as described in claim 1 further comprising an aperture traversing said base.

7. The concrete receptacle assembly as described in claim 1, further comprising:
at least one bracket rigidly affixed to said outer surface of said frame to assist in upending said frame.

8. The concrete receptacle assembly as described in claim 1, further comprising a railing affixed to said frame.

9. The concrete receptacle assembly as described in claim 1, wherein said frame comprises:
a pair of horizontal walls; and
a pair of vertical walls connected between said horizontal walls.

10. The concrete receptacle assembly as described in claim 9 further comprising:
a pair of said first partitions, said first partitions connected between said horizontal walls of said frame, wherein each said first partition of said pair is angled toward said other first partition of said pair; and
a pair of said second partitions, said second partitions connected between said vertical walls of said frame, wherein each said second partition of said pair is angled toward said other second partition of said pair.

11. A method for forming riprap using waste concrete comprising the steps of:
a) placing a frame on a ground surface, said frame having a first partition and a second partition, said first partition connected to said second partition by a base, said first partition, second partition and base defining at least one cell;
b) applying a lubricant to said at least one cell;
c) distributing the waste concrete into said at least one cell;
d) allowing said waste concrete to cure in said at least one cell into a riprap block having a shape conforming to said at least one cell; and
e) substantially inverting said frame to allow said riprap block to be displaced from said at least one cell.

12. The method for forming riprap as described in claim 7, wherein step a) further comprises:
providing said frame with said first partition being tapered toward said second partition.

13. The method for forming riprap as described in claim 7, wherein step d) further comprises:
maintaining said frame in a stationary position for at least eight hours.

14. The method for forming riprap as described in claim 9, wherein step e) further comprises:
engaging an arm attached to said frame to lift said arm and said frame from the ground surface.

15. A method for recycling waste concrete into synthetic riprap blocks comprising the steps of:
a) placing a frame on a ground surface, said frame having an inner surface and an outer surface, wherein a first partition and a second partition are mounted to said inner surface of said frame to define at least one cell;
b) covering said at least one cell with a lubricant;
c) dispersing the waste concrete into said cell;
d) storing said frame for a predetermined period of time; and
e) upending said frame to dislodge the synthetic riprap block from said cell.

16. The method for recycling waste concrete into synthetic riprap blocks as described in claim 15, wherein step a) further comprises angling said first partition toward said second partition.

17. The method for recycling waste concrete into synthetic riprap blocks as described in claim 15, wherein step d) further comprises the step of allowing the waste concrete to cure for a period of at least eight hours.

18. The method for recycling waste concrete into synthetic riprap blocks as described in claim 15, wherein step e) further comprises:
engaging a clasp attached to said frame; and
rotating said frame from the ground surface.

19. The method for recycling waste concrete into synthetic riprap blocks as described in claim 18 further comprising the step of lifting said frame with a machine.
